(19) United States
(12) Patent Application Publication
(10) Pub. No.: US 2012/0030111 A1
(43) Pub. Date: Feb. 2, 2012

(54) SERVICE PLATFORM UTILIZING AN ELECTRONIC PAPER DEVICE FOR FINANCIAL INSTITUTIONS

(76) Inventors: Sung-Hui HUANG, Sijhih City (TW); Yao-Chou Tsai, Taipei City (TW); Ted-Hong Shinn, Hsinchu City (TW)

(21) Appl. No.: 12/847,159

(22) Filed: Jul. 30, 2010

(51) Int. Cl. G06Q 40/00

(52) U.S. Cl. 705/44; 705/35; 705/39

(57) ABSTRACT

A service platform utilizing an electronic paper device for financial institutions, comprising: an option input device, used for sensing an entry operation and outputting a financial business option signal accordingly; a control unit, having an option input interface, a display interface, a host interface, and a slips storage unit, wherein the option input interface is used to receive the financial business option signal, the host interface is used to communicate with a financial institution host, the slips storage unit is used to store financial business slips; and an electronic paper device, having a touch input function, coupled to the display interface to display one financial business slip for related information input by a touch pen, or transmit the related information through the control unit to the financial institution host, or display an informing message sent from the financial institution host through the control unit.

### BACKGROUND OF THE INVENTION

1. Field of the Invention

The present invention relates to a financial institution service platform, especially to a service platform utilizing an electronic paper device for financial institutions to provide convenient and efficient financial business services complying with environment protection requirement.

2. Description of the Related Art

As is often seen in the traditional proceeding of financial businesses, paper sheets are consumed. For example, when one performs a financial business such as deposit, remittance, withdrawal, or loan in a financial institution like bank, post office, or farmers' association, first, he/she will generally draw a paper sheet printed with a queuing number, and then take a slip provided by the financial institution and fill in related information for the financial business.

During the filling process, if any fill-in error happens as is often seen, he/she has to take another slip to write the related information again. Besides, during the traditional financial business proceeding, he/she may have to fill in tedious and bothering personal information such as name, address, phone number, not only time consuming but also inconvenient. In view of these disadvantages, the present invention discloses an electronic paper application device, which is capable of replacing the paper sheets involved in the financial business—such as deposit, remittance, withdrawal, or loan—proceeding with an electronic book to save paper resource and deliver people from the drudgery of tedious and bothering personal information writing.

### SUMMARY OF THE INVENTION

The primary objective of the present invention is to disclose a service platform utilizing an electronic paper device for financial institutions to provide convenient and efficient financial business services, which comply with environment protection requirement.

To accomplish the foregoing objective, a service platform utilizing an electronic paper device for financial institutions is proposed, the service platform comprising: an option input device, used for sensing an entry operation and outputting a financial business option signal accordingly; a control unit, having an option input interface, a display interface, a host interface, and a slips storage unit, wherein the option input interface is used to receive the financial business option signal, the host interface is used to communicate with a financial institution host, the slips storage unit is used to store at least one financial business slip; and an electronic paper device, having a touch input function, coupled to the display interface to display one of the at least one financial business slip for related information input by a touch pen, or transmit the related information through the control unit to the financial institution host, or display an informing message sent from the financial institution host through the control unit.

The service platform can be embedded on a table in a financial institution such as bank, post office, or farmers' association. When a user enters the financial institution for a financial business, first, he/she goes to the desk to push a button representing the financial business—for example, a deposit button, and the electronic paper device of the service platform will display an image of a deposit slip. The user then uses a touch pen to fill in the information needed for deposit proceeding. After filling out the slip, the user pushes an information confirming button to transmit the input content to the counter of the financial institution in wired or wireless manner. After a short time, the user will see a queuing number displayed on the electronic paper device, and he/she can go to the counter to complete follow-up procedures when the counter indicates his/her queuing number.

To further save user's operation time, the present invention further adds a password input area in each slip for users to input a predetermined password. Taking deposit proceeding as an example, if the input password is confirmed by the control unit of the service platform, then the user only has to input a deposit amount, with the drudgery of inputting tedious and bothering personal information like address, phone number, etc. eliminated—as the personal information was stored in the financial institution host beforehand, to inform the financial institution host of the deposit proceeding requirement through the control unit.

To make it easier for our examiner to understand the objective of the invention, its structure, innovative features, and performance, we use a preferred embodiment together with the accompanying drawings for the detailed description of the invention.

### BRIEF DESCRIPTION OF THE DRAWINGS

FIG. 1 is a block diagram of a service platform utilizing an electronic paper device for financial institutions according to a preferred embodiment of the present invention.

FIG. 2 is a block diagram of a service platform utilizing an electronic paper device for financial institutions according to another preferred embodiment of the present invention.

### DETAILED DESCRIPTION OF THE PREFERRED EMBODIMENTS

The present invention will be described in more detail hereinafter with reference to the accompanying drawings that show the preferred embodiment of the invention.

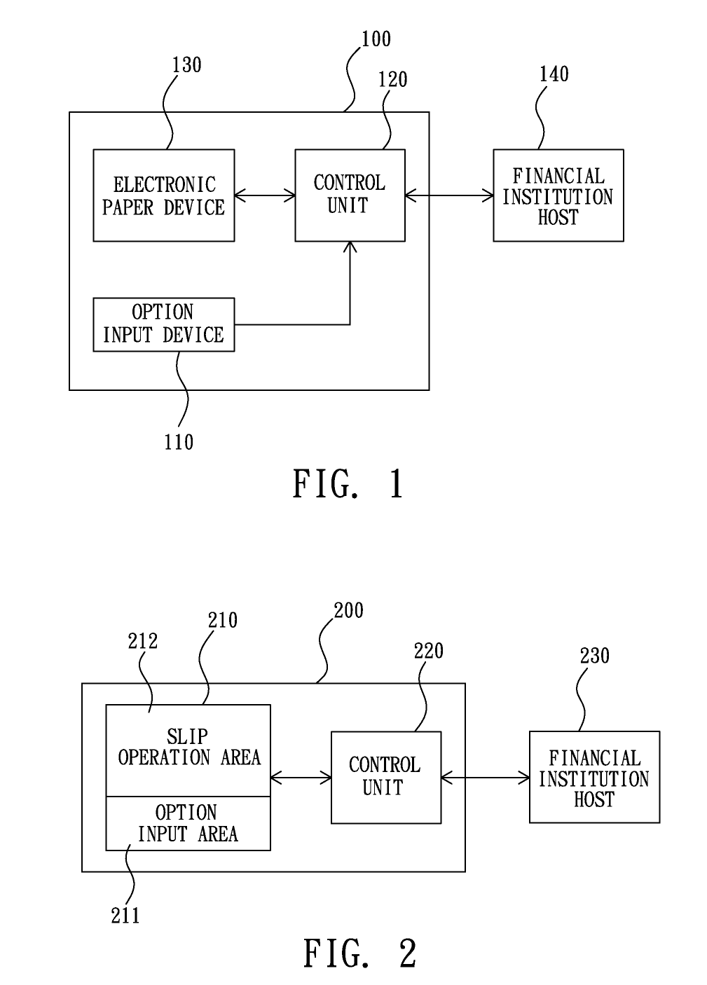

Please refer to FIG. 1, which shows a block diagram of a service platform utilizing an electronic paper device for financial institutions according to a preferred embodiment of the present invention. As shown in FIG. 1, a service platform 100, used to communicate with a financial institution host 140, includes an option input device 110, a control unit 120 and an electronic paper device 130.

The option input device 110, used for sensing an entry operation and outputting a financial business option signal accordingly, is preferably a keypad input device, and the option buttons of which preferably include withdrawal button, deposit button, remittance button, clear button and enter button, wherein the withdrawal button is used to choose a deposit slip, the deposit button is used to choose a deposit slip, the remittance button is used to choose a remittance slip, the clear button is used to delete a specific entry in a chosen slip, and the enter button is used to confirm the entry information input in a chosen slip. When one of the option buttons is pressed, a corresponding command carried by the financial business option signal is sent to the control unit 120.

The control unit 120 has an option input interface, a display interface, a host interface, and a slips storage unit, wherein the option input interface is used to receive the financial business option signal; the display interface is used to communicate with the electronic paper device 130; the host interface is used to communicate with the financial institution host 140 in a wired manner such as through a USB (Universal Serial Bus) interface, or a wireless manner such as through Bluetooth, WiFi, infrared, or RFID; and the slips storage unit is used to store at least one financial business slip like withdrawal slip, deposit slip, remittance slip, or queuing number slip etc.

The electronic paper device 130 has a touch input function, coupled to the display interface of the control unit 120 to display one of the at least one financial business slip for related information input by a touch pen, or transmit the related information through the control unit 120 to the financial institution host 140, or display an informing message sent from the financial institution host 140 through the control unit 120. The electronic paper device 130 can be implemented with a touch electrophoresis display, a MEMS (Micro Electro Mechanical System) display, a cholesteric liquid crystal display, a electrowetting display, a liquid crystal display, an organic/inorganic Electroluminescence display, or an electrochromic display.

When a user is to perform a financial business, for example a withdrawal business, in the financial institution, he/she can press the withdrawal button provided by the option input device 110, and a corresponding command is sent from the option input device 110 to the control unit 120, to have information of a withdrawal slip transmitted to the electronic paper device 130 and then displayed. The user can fill in the withdrawal slip with related information by a touch pen and then press the enter button of the option input device 110 to have the control unit 120 read the related information and send it to the financial institution host 140. After receiving the related information, the financial institution host 140 will send an informing message, for example, a queuing number information, to the control unit 120, and the control unit 120 will put the queuing number in a queuing number slip and then send the queuing number slip to the electronic paper device 130 to inform the user. To further save user's operation time, a password input area can be added in each slip for users to input a predetermined password. Taking the deposit business as an example, if the input password is confirmed by the control unit, then the user only has to input a deposit amount, with the drudgery of inputting the tedious and bothering personal information such as address, phone number, etc. eliminated—because the personal information could be stored in the financial institution host 140 beforehand, to inform the financial institution host 140 of the deposit business request by the control unit 120.

To further reduce the hardware cost, the present invention proposes another preferred embodiment integrating the option input device into the electronic paper device, of which the block diagram is illustrated in FIG. 2. As shown in FIG. 2, a service platform 200, used to communicate with a financial institution host 230, includes an electronic paper device 210 and a control unit 220.

The electronic paper device 210 has an option input area 211 and a slip operation area 212. After power on, the control unit 220 will send the information of button icon patterns including for example but not limited to icon patterns of a withdrawal button, a deposit button, a remittance button, a clear button and an enter button to the option input area 211 of the electronic paper device 210, to facilitate user's choosing a financial business service. The electronic paper device 210 can be implemented with a touch electrophoresis display, a MEMS (Micro Electro Mechanical System) display, a cholesteric liquid crystal display, a electrowetting display, a liquid crystal display, an organic/inorganic Electroluminescence display, or an electrochromic display.

The control unit 220 has a display interface, a host interface, and a slips storage unit, wherein the display interface is used to communicate with the electronic paper device 210; the host interface is used to communicate with the financial institution host 230 in a wired manner such as through a USB (Universal Serial Bus) interface, or a wireless manner such as through Bluetooth, WiFi, infrared, or RFID; and the slips storage unit is used to store at least one financial business slip like withdrawal slip, deposit slip, remittance slip, or queuing number slip etc.

When a user is to perform a financial business, for example a withdrawal business, in the financial institution, he/she can press the withdrawal button provided by the option input area 211, and a corresponding command is sent from the electronic paper device 210 to the control unit 220, to have information of a withdrawal slip transmitted to the slip operation area 212 of the electronic paper device 210. The user can fill out the withdrawal slip with related information by a touch pen and then press the enter button of the option input area 211 to have the control unit 220 read the related information and send it to the financial institution host 230. After receiving the related information, the financial institution host 230 will send an informing message, for example, a queuing number information, to the control unit 220, and the control unit 220 will put the queuing number in a queuing number slip and then send the queuing number slip to the slip operation area 212 of the electronic paper device 210 to inform the user.

To further save user's operation time, a password input area can be added in each slip for users to input a predetermined password. Taking the deposit business as an example, if the input password is confirmed by the control unit, then the user only has to input a deposit amount, with the drudgery of inputting the tedious and bothering personal information such as address, phone number, etc. eliminated—because the personal information can be stored in the financial institution host 140 beforehand, to inform the financial institution host 140 of the deposit business request by the control unit 120.

In conclusion, the service platform utilizing an electronic paper device for financial institutions of the present invention not only can save paper resource and thereby comply with the environment protecting requirement, but also can simplify the slip fill-in procedure to save user's operation time, so the present invention does have overcome the disadvantages of the prior art financial institutions.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A service platform utilizing an electronic paper device for financial institutions, comprising:
an option input device, used for sensing an entry operation and outputting a financial business option signal accordingly;
a control unit, having an option input interface, a display interface, a host interface, and a slips storage unit, wherein said option input interface is used to receive said financial business option signal, said host interface is used to communicate with a financial institution host, said slips storage unit is used to store at least one financial business slip; and
an electronic paper device, having a touch input function, coupled to said display interface to display one of said at least one financial business slip for related information input by a touch pen, or transmit said related information through said control unit to said financial institution host, or display an informing message sent from said financial institution host through said control unit.

2. The service platform utilizing an electronic paper device for financial institutions as claim 1, wherein said option input device comprises a deposit option.

3. The service platform utilizing an electronic paper device for financial institutions as claim 1, wherein said option input device comprises a remittance option.

4. The service platform utilizing an electronic paper device for financial institutions as claim 1, wherein said option input device comprises a withdrawal option.

5. The service platform utilizing an electronic paper device for financial institutions as claim 1, wherein said option input device comprises an information deletion option.

6. The service platform utilizing an electronic paper device for financial institutions as claim 1, wherein said option input device comprises an entry confirming option.

7. The service platform utilizing an electronic paper device for financial institutions as claim 1, wherein said electronic paper device is one device selected from the group consisting of touch electrophoresis display, MEMS (Micro Electro Mechanical System) display, cholesteric liquid crystal display, electrowetting display, liquid crystal display, organic/inorganic Electroluminescence display, and electrochromic display.

8. The service platform utilizing an electronic paper device for financial institutions as claim 1, wherein at least one of said at least one financial business slip further comprises a password input area.

9. The service platform utilizing an electronic paper device for financial institutions as claim 1, wherein said host interface utilizing one technology selected from the group consisting of USB, WiFi, infrared, and RFID to communicate with said financial institution host.

10. A service platform utilizing an electronic paper device for financial institutions, comprising:
a control unit, having a display interface, a host interface, and a slips storage unit, wherein said host interface is used to communicate with a financial institution host, said slips storage unit is used to store at least one financial business slip; and
an electronic paper device, coupled to said display interface, having an option input area for sensing an entry operation, and a slip operation area for displaying one of said at least one financial business slip for related information input by a touch pen, said electronic paper device being used to transmit said related information through said control unit to said financial institution host, or display an informing message sent from said financial institution host through said control unit.
